(19) United States
(12) Patent Application Publication
(10) Pub. No.: US 2013/0015687 A1
(43) Pub. Date: Jan. 17, 2013

(54) SEAT COMPRISING A SEAT SCREEN UNIT

(71) Applicant: Marco Krämer, Wolpertshausen (DE)

(72) Inventor: Marco Krämer, Wolpertshausen (DE)

(21) Appl. No.: 13/580,413

(22) PCT Filed: Feb. 25, 2011
(86) PCT No.: PCT/EP2011/000918

§ 371 Date: Sep. 27, 2012

(30) Foreign Application Priority Data
Feb. 27, 2010 (DE) 10 2010 009 626.1

(51) Int. Cl. B64D 11/06; B23P 11/00; A47C 7/72

(52) U.S. Cl. 297/217.3; 29/426.3

(57) ABSTRACT

The invention relates to a seat including a backrest unit which has at least one seat screen unit, which in a ready-for-operation state displays output signals from an image converter unit, wherein the output signals are transmitted by a signal transmission unit between the image converter unit and the seat screen unit. According to the invention, the seat screen unit has at least one output interface which is provided to transmit signals between the image converter unit and the seat screen unit, and the image converter unit is disposed outside the seat screen unit.

### CROSS REFERENCE TO RELATED APPLICATIONS

This application is a U.S. national stage application of PCT/EP2011/000918 filed on Feb. 25, 2011, and claims priority to, and incorporates by reference, German patent application No. 10 2010 009 626.1 filed on Feb. 27, 2010.

### BACKGROUND

The invention proceeds from a seat apparatus, in particular an aircraft passenger seat apparatus, as claimed in the preamble of patent claim 1.

Seat apparatuses having a screen integrated in a backrest are already known. In this arrangement, the screen is provided for the purpose of providing entertainment and information to a passenger sitting behind the seat apparatus. The backrest has a cutout in which the screen is held with the aid of attachment means. A video signal is transmitted via a video cable which is connected to a screen housing, with the screen signal being processed in a known manner by an image converter, which is located in the screen housing, in order to be displayed on the screen.

The invention is based, in particular, on the object of reducing the weight of the seat apparatus by saving on material, while maintaining the comfort of the seat. This object is achieved by a seat apparatus as claimed in patent claim 1. Further advantageous embodiments of the invention can be gathered from the dependent claims.

### SUMMARY

The invention proceeds from a seat apparatus having a backrest unit which has at least one seat screen unit which is provided for the purpose of displaying output signals from an image converter unit in a ready-to-operate state, with the output signals being transmitted by a signal transmission unit between the image converter unit and the seat screen unit. In this case, a “backrest unit” is intended to be understood to mean, in particular, a unit of a seat apparatus which has at least a backrest and a rear backrest cover. In this context, a “seat screen unit” is intended to be understood to mean, in particular, a unit which has a screen and a screen frame which at least partially surrounds the screen, with the screen being provided for the purpose of displaying specific output signals from a corresponding image converter unit. The screen may preferably be a liquid crystal screen. In this case, “provided” is intended to be understood to mean, in particular, specially equipped and/or designed. In this context, an “image converter unit” is intended to be understood to mean, in particular, an arrangement of electronic components which is provided for the purpose of converting a standardized input signal into an output signal using a signal conversion unit and generating a supply voltage. Furthermore, the image converter unit can have at least one cooling unit. A “standardized input signal” is intended to be understood to mean, in particular, an analog or digital signal which is generated in an external multimedia device or computer, preferably in a signal format which is standardized in a known manner. In this context, a “specific output signal” is intended to be understood to mean, in particular, a signal which is specifically matched to the seat screen unit and the image converter unit and which is provided for the purpose of transmitting information between the image converter unit and the seat screen unit. With particular preference, the output signal can transmit image information from the image converter unit to the seat screen unit. In this context, a “signal transmission unit” is intended to be understood to mean, in particular, an electrical and/or optical connection element which is provided for the purpose of transmitting signals between the image converter unit and the seat screen unit. The signal transmission unit may preferably be an electrical cable, particularly preferably an electrical conductor track.

It is proposed that the seat screen unit has at least one output interface which is provided for the purpose of transmitting signals between the image converter unit and the seat screen unit, and that the image converter unit is arranged outside the seat screen unit. In this case, an “output interface” is intended to be understood to mean, in particular, an electrical interface which leads from the screen, through the screen frame, to the outside. As a result, the image converter unit can advantageously be arranged independently of the seat screen unit. The image converter unit can preferably be arranged at points at which advantageously only low torques, which are generated by an acceleration of the image converter unit, act on the seat apparatus. As a result, savings can advantageously be made on material and weight, and smaller dimensions and simpler constructions can also be achieved.

In a further refinement of the invention, it is proposed that the seat apparatus has an accommodation unit which is provided for the purpose of accommodating the seat screen unit, so that a surface of the seat screen unit, in a stowed position, forms a closed contour with a rear surface of the backrest cover. As a result, the safety of a passenger sitting behind the seat apparatus can advantageously be increased and the risk of injury can be reduced in the stowed position. The surface of the seat screen unit preferably faces the passenger sitting behind the seat apparatus. The surface can preferably terminate with the backrest cover.

It is also proposed that the backrest unit has an accommodation unit which is provided for the purpose of accommodating the image converter unit. As a result, the backrest unit and the image converter unit can be replaced together in a particularly simple and quick manner.

In a further advantageous refinement, the seat apparatus has an inclination adjustment unit for coupling the seat screen unit to the backrest unit in an adjustable manner, as a result of which a passenger sitting behind the seat apparatus is able to individually set a viewing angle in respect of the seat screen unit by rotating the surface about an axis. The orientation can particularly preferably be performed about an axis which is substantially perpendicular to an axis which is oriented in the seat direction. In this context, a “seat direction” is intended to be understood to mean a direction which is oriented parallel to a floor and perpendicular to a front edge of the seat apparatus and leads away from the backrest unit.

If the seat apparatus has at least one electromagnetic shield element which is provided for the purpose of significantly damping electromagnetic radiation, undesired emission of electromagnetic waves and/or an effect by electromagnetic waves which act from the outside can advantageously be avoided. In this context, electromagnetic radiation is intended to be understood to mean, in particular, electromagnetic radiation at least in the frequency range of between 10 MHz and 10 GHz. In this context, “significant damping” is intended to be understood to mean, in particular, damping of at least 20 dB at a frequency of 100 MHz in one amplitude of the electromagnetic radiation. The electromagnetic shield element can preferably be arranged in the immediate vicinity of the signal transmission unit, as a result of which the signal from the image converter unit can be transmitted particularly without interference.

It is also proposed that the seat screen unit has a liquid crystal screen, as a result of which a particularly lightweight and flat design can be achieved. The liquid crystal screen is particularly preferably in the form of a TFT screen (TFT: thin-film transistor).

A seat display system is also proposed, said seat display system being equipped with a seat apparatus, with an image converter unit, with the image converter unit having been provided for the purpose of generating output signals to be displayed by the seat screen unit of the backrest unit, and with a signal transmission unit which is provided for the purpose of transmitting the signals generated by the image converter unit to the seat screen unit. As a result, savings can advantageously be made on material and weight and smaller dimensions and simpler constructions of the seat apparatus can also be achieved.

If the signal transmission unit of the seat display system comprises at least one electrical conductor track which is integrated in the seat apparatus, the signal transmission unit can be protected in a particularly simple manner against external mechanical and/or electromagnetic influences. The conductor track can preferably be vapor-deposited or with particular preference sprayed on. Methods which are suitable for the above are known to a person skilled in the art.

It is also proposed that the seat display system is equipped with a releasable electrical connection element which, in a ready-to-operate state, is arranged between the image converter unit and a video signal transmission unit. In this case, a “video signal transmission unit” is intended to be understood to mean, in particular, a unit which transmits video signals from a multimedia device and/or from a computer to the image converter unit. The backrest unit can be disconnected from the seat apparatus and replaced in a particularly simple and quick manner by virtue of the releasable electrical connection element.

In a further refinement, it is proposed that the image converter unit has an image converter which is provided for the purpose of converting an input signal of the video signal transmission unit into an output signal which is specifically matched to the seat screen unit. As a result, the output signal can be displayed by the seat screen unit without further post-processing, as a result of which use of an image converter within the seat screen unit can advantageously be avoided. The image converter unit can advantageously have at least one cooling element which is provided for the purpose of dissipating any heat which has been produced in the image converter unit, as a result of which a particularly compact construction can be achieved.

It is also proposed that the image converter unit has at least one voltage converter which is provided for the purpose of supplying at least one electrical supply voltage to the seat screen unit in a ready-to-operate state. As a result, power can be supplied to the seat screen unit in a particularly simple manner and without interference.

### BRIEF DESCRIPTION OF THE DRAWINGS

Further advantages can be found in the following description of the drawing. The drawing shows an exemplary embodiment of the invention. The description and the claims contain numerous features in combination. A person skilled in the art will expediently also consider the features individually and combine said features to form meaningful further combinations.

FIG. 1 is a schematic view of a seat having a seat display system,

FIG. 2 is a cross sectional view of the seat according to FIG. 1, and

FIG. 3 is a schematic view of a detail of a backrest unit of the seat display system according to FIG. 1.

### DETAILED DESCRIPTION

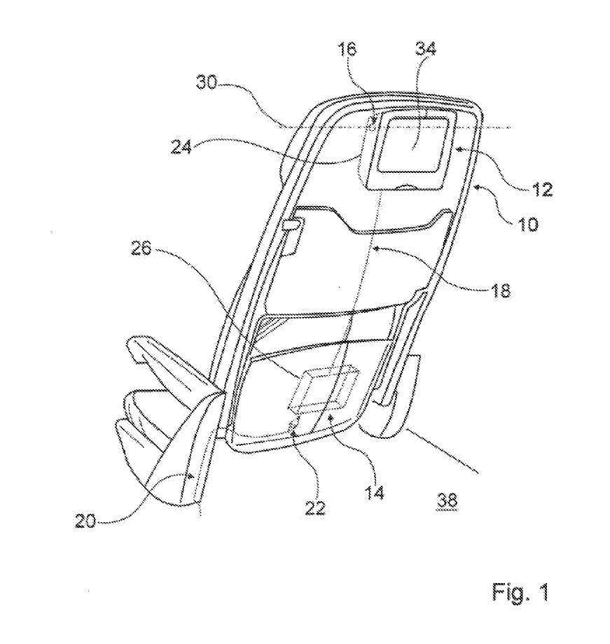

FIG. 1 shows a perspective view of a seat according to the invention having a seat display system. The seat is mounted on a floor 38 of an aircraft cabin in a manner which is known and not described in any detail here. The seat display system comprises a seat apparatus with a backrest unit 10 which is fitted on the rear of the seat apparatus in relation to a seat direction 28 and which has a seat screen unit 12. In this context, a “seat direction” 28 is intended to be understood to mean a direction which is oriented parallel to the floor 38 and perpendicular to a front edge 33 of the seat apparatus and leads away from the backrest unit 10. The seat direction 28 typically corresponds to a flight direction. In this description, the terms “in front of”, “behind”, “to the rear”, “to the front”, “front face”, “forward face”, “rear face”, etc. relate to the seat direction 28. Furthermore, the terms “at the top”, “at the bottom”, “above”, “below” etc. relate to a vertical direction which is oriented perpendicular to the floor 38 and starts from said floor. Although not illustrated here, several of these seats can be arranged in a row, and several rows of seats can be arranged one behind the other in the seat direction 28 in a known manner.

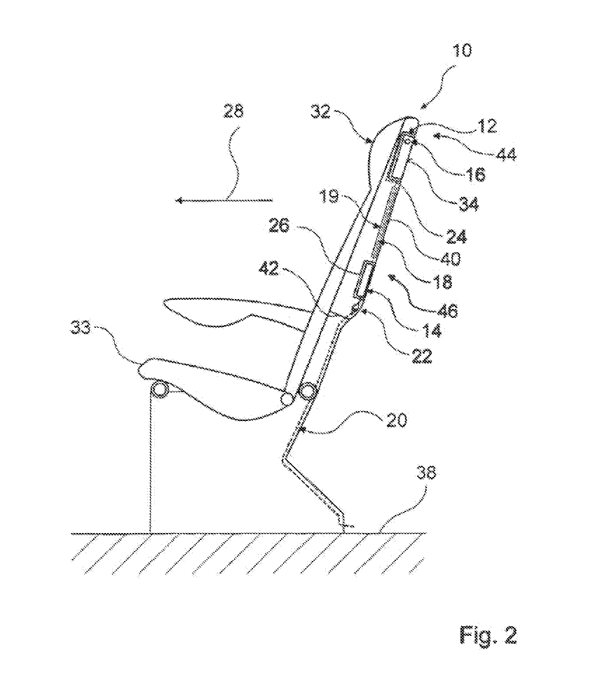

The seat display system also comprises an image converter unit 14, an inclination adjustment unit 16 and a signal transmission unit 18. The backrest unit 10 is intended to accommodate a cushion unit 32 (FIG. 2) on a side which faces the seat direction 28.

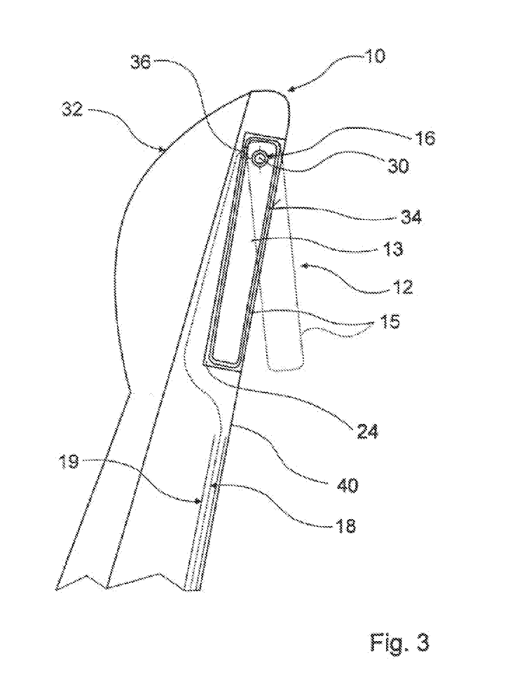

The backrest unit 10 is releasably attached to the rear of the seat apparatus by attachment means which are not illustrated for the sake of clarity. The backrest unit 10 terminates flush with the seat apparatus at a separation point 42. The backrest unit 10 also has an accommodation unit 24 in an upper region 44, said accommodation unit being provided for the purpose of accommodating the seat screen unit 12, so that a surface 34 of the seat screen unit 12, in a stowed position, forms a closed contour with a rear surface of the backrest unit 10. The seat screen unit 12 in the stowed position is illustrated by way of a solid line in FIG. 3. The accommodation unit 24 is in the form of a recess which is open at the rear in a backrest cover 40 which is attached to the backrest unit 10. The backrest cover 40 covers the backrest unit 10 at the rear and protects the components contained in said backrest unit against external influences.

Furthermore, the seat apparatus has an inclination adjustment unit 16 for coupling the seat screen unit 12 to the backrest unit 10 in an adjustable manner. The inclination adjustment unit 16 is designed as a rotary joint (not illustrated in any detail) and allows the seat screen unit 12 to be pivoted from the stowed position to a viewing position about a rotation axis 30 which is perpendicular to a seat direction 28 and parallel to the floor 38, in order to be able to individually set the viewing angle of the surface 34 of the seat screen unit 12 for a passenger sitting behind the seat apparatus. A dashed line shows the seat screen unit 12 in the viewing position in FIG. 3. If the seat screen unit 12 is in the stowed position, the surface 34 of the seat screen unit 12 forms a closed contour with the rear surface of the backrest unit 10 (FIG. 3). Therefore, no parts of the seat screen unit 12 project into the space behind the seat apparatus in the stowed position, as a result of which the safety of the passenger sitting to the rear is increased.

Furthermore, the backrest unit 10 has an accommodation unit 26 which is provided for the purpose of accommodating the image converter unit 14 (FIG. 1, FIG. 2). The accommodation unit 26 is formed by a plastic housing which is arranged in front of the backrest cover 40 and surrounds the image converter unit 14 in the mounted state. The plastic housing has a first opening, through which the signal transmission unit 18 is routed, in the upper region and a second opening, at which a releasable connection element 22 of the seat display system for connection to a video signal transmission unit 20 is arranged, in the lower region.

The seat screen unit 12 has a liquid crystal screen 13, which is in the form of a TFT screen, which is at least partially surrounded by a screen frame 15. The seat screen unit 12 is installed in the accommodation unit 24 with a clearance between the screen frame 15 and the accommodation unit 24 (FIG. 3), said clearance being provided for the purpose of enabling the seat screen unit 12 to pivot between the stowed position and the viewing position in a friction- and wear-free manner.

The screen frame 15 of the seat screen unit 12 has an output interface 36 which comprises an electrical plug connection. The output interface 36 is provided for the purpose of transmitting signals between the image converter unit 14 and the seat screen unit 12. An outer face of the screen frame 15 has a socket for accommodating a plug of the electrical plug connection. The signal transmission unit 18 is connected to the socket in a ready-to-operate state (FIG. 3).

The seat apparatus also has an electromagnetic shield element 19 in a central region of the backrest unit 10, said shield element being provided for the purpose of damping electromagnetic radiation by more than 60 dB at a frequency of 100 MHz. The electromagnetic shield element 19 is in the form of a conductor track shield and has a copper foil which is provided for the purpose of reducing the effect of electromagnetic radiation which acts from the outside and of avoiding emission of electromagnetic radiation by the conductor track (FIG. 2).

The illustrated seat display system is equipped with a seat apparatus and an image converter unit 14 which is provided for the purpose of generating output signals to be displayed by the seat screen unit 12. The image converter unit 14 is arranged in an accommodation unit 26 in a lower region 46 of the backrest unit 10 (FIG. 2). The accommodation unit 26 is attached to a frame of the backrest unit 10. The image converter unit 14 is advantageously protected against external influences by the accommodation unit 26.

The image converter unit 14 has an image converter which is provided for the purpose of converting an input signal of the video signal transmission unit 20 into an output signal which is specifically matched to the seat screen unit 12. The input signal and the output signal are in a digital format. The digital output signal is calculated from the digital input signal and displayed on the seat screen unit 12 by a multiplexing method (not explained in any detail). A further image converter in the seat screen unit 12 is advantageously avoided as a result.

The image converter unit 14 also has two voltage converters which are provided for the purpose of generating two different supply voltages for the seat screen unit 12. The first voltage converter reduces a voltage of 28 VDC from an external voltage source to 5 VDC in order to supply the image converter. The second voltage converter converts the voltage from the external voltage source to 630 VAC for supplying a background lighting means (not described in any detail) of the TFT screen.

Furthermore, the seat display system is equipped with a signal transmission unit 18 which is provided for the purpose of transmitting signals generated by the image converter unit 14 to the seat screen unit 12. The signal transmission unit 18 has two electrical conductor tracks which are integrated in the seat apparatus and in each case one plug connection at each end. The conductor tracks are connected to the image converter unit 14 and the seat screen unit 12 and run in the backrest unit 10 on an inner face of the backrest cover 40. The conductor tracks are in the form of sprayed-on layers. The conductor tracks are illustrated at a short distance from the backrest cover 40 (FIG. 2, FIG. 3) for explanatory purposes. The conductor tracks are provided for the purpose of transmitting signals containing image information from the image converter unit 14 to the seat screen unit 12 and user input information from the seat screen unit 12 to the image converter unit 14 (FIGS. 1-3).

The seat display system has a releasable connection element 22 which is arranged between the image converter unit 14 and a video signal transmission unit 20 in a ready-to-operate state. The releasable connection element 22 is in the form of an electrical plug connection which establishes a releasable connection between the image converter unit 14 and the video signal transmission unit 20, as a result of which the backrest unit 10 can be removed from the seat apparatus and mounted in a simple and quick manner (FIG. 1, FIG. 2).

The video signal transmission unit 20, which is provided for the purpose of transmitting a video signal from an external video signal source (not illustrated) and also for providing a supply voltage, comprises a cable and also a shield element which protects against undesired irradiation or emission of electromagnetic waves.

1. A seat apparatus having a backrest unit which has at least one seat screen unit which is provided for the purpose of displaying, in a ready-to-operate state, output signals from an image converter unit, with the output signals being transmitted by a signal transmission unit between the image converter unit and the seat screen unit, wherein the seat screen unit has at least one output interface which is provided for the purpose of transmitting signals between the image converter unit and the seat screen unit, and in that the image converter unit is arranged outside the seat screen unit.

2. The seat apparatus as claimed in claim 1, comprising an accommodation unit which is provided for the purpose of accommodating the seat screen unit, so that a surface of the seat screen unit, in a stowed position, forms a closed contour with a rear surface of the backrest unit.

3. The seat apparatus as claimed in claim 1, wherein the backrest unit has an accommodation unit which is provided for the purpose of accommodating the image converter unit.

4. The seat apparatus as claimed in claim 1, comprising an inclination adjustment unit for coupling the seat screen unit to the backrest unit in an adjustable manner.

5. The seat apparatus as claimed in claim 1, comprising at least one electromagnetic shield element which is provided for the purpose of significantly damping electromagnetic radiation.

6. The seat apparatus as claimed in claim 1, wherein the seat screen unit has a liquid crystal screen.

7. A seat display system having a seat apparatus as claimed in claim 1, comprising an image converter unit which is provided for the purpose of generating output signals to be displayed by the seat screen unit, and further comprising a signal transmission unit which is provided for the purpose of transmitting the signals generated by the image converter unit to the seat screen unit.

8. The seat display system as claimed in claim 7, wherein the signal transmission unit comprises at least one electrical conductor track which is integrated in the seat apparatus.

9. The seat display system as claimed in claim 7, comprising a releasable connection element which, in a ready-to-operate state, is arranged between the image converter unit and a video signal transmission unit.

10. The seat display system as claimed in claim 7, wherein the image converter unit has an image converter which is provided for the purpose of converting an input signal of the video signal transmission unit into an output signal which is specifically matched to the seat screen unit.

11. The seat display system as claimed in claim 7, wherein the image converter unit has at least one voltage converter which is provided for the purpose of generating at least one supply voltage for the seat screen unit.

12. A seat, in particular an aircraft seat, having a seat display system as claimed in claim 7.

13. A method for replacing a backrest unit of a seat as claimed in claim 12, which method comprises the following steps:
disconnecting a releasable connection element between a video signal transmission unit and an image converter unit, and
removing the backrest unit from the seat apparatus.

14. The seat apparatus as claimed in claim 2, wherein the backrest unit has an accommodation unit which is provided for the purpose of accommodating the image converter unit.

15. The seat apparatus as claimed in claim 2 comprising an inclination adjustment unit for coupling the seat screen unit to the backrest unit in an adjustable manner.

16. The seat apparatus as claimed in claim 3 comprising an inclination adjustment unit for coupling the seat screen unit to the backrest unit in an adjustable manner.

17. The seat apparatus as claimed in claim 2, comprising at least one electromagnetic shield element which is provided for the purpose of significantly damping electromagnetic radiation.

18. The seat apparatus as claimed in claim 3, comprising at least one electromagnetic shield element which is provided for the purpose of significantly damping electromagnetic radiation.

19. The seat apparatus as claimed in claim 4, comprising at least one electromagnetic shield element which is provided for the purpose of significantly damping electromagnetic radiation.

20. The seat display system as claimed in claim 8, comprising a releasable connection element which, in a ready-to-operate state, is arranged between the image converter unit and a video signal transmission unit.
